(19) United States
(12) Patent Application Publication
(10) Pub. No.: US 2026/0303970 A1
(43) Pub. Date: Oct. 1, 2026

(54) CONTROL APPARATUS, IMAGE PICKUP APPARATUS, CAMERA SYSTEM, CONTROL METHOD, AND STORAGE MEDIUM

(71) Applicant: CANON KABUSHIKI KAISHA, Tokyo (JP)

(72) Inventor: HIDECHIKA INAGAKI, Kanagawa (JP)

(21) Appl. No.: 19/530,809

(22) Filed: Feb. 5, 2026

(30) Foreign Application Priority Data
Feb. 26, 2025 (JP) 2025-029092

(51) Int. Cl. H04N 23/68; H04N 23/695

(52) U.S. Cl. CPC H04N 23/683; H04N 23/6812; H04N 23/687; H04N 23/695

(57) ABSTRACT

A control apparatus for use in a camera system including an image pickup apparatus includes one or more memories storing instructions, and one or more processors that, upon execution of the instructions, operate to acquire information on a moving direction of the image pickup apparatus and shake information of the camera system, and correct shake information according to the information on the moving direction and the shake information when the image pickup apparatus is moving.

### BACKGROUND

### Field of the Technology

The present disclosure relates to one or more embodiments of a control apparatus, an image pickup apparatus, a camera system, a control method, and a storage medium.

### Description of the Related Art

Conventionally, shake correction is performed based on a detection signal from a detector configured to detect shake, but if the detection axis of the detector shifts from the correction axis of a corrector configured to correct shake, the correction effect against shake is reduced. Japanese Patent Application Laid-Open No. 2004-194157 discloses a configuration configured to convert a detection signal or a correction signal based on the detection signal into a value that corresponds to a correction axis of a corrector.

### SUMMARY

A control apparatus according to one aspect of the present disclosure for use in a camera system including an image pickup apparatus may include one or more memories storing instructions, and one or more processors that, upon execution of the instructions, operate to acquire information on a moving direction of the image pickup apparatus and shake information of the camera system, and correct shake information according to the information on the moving direction and the shake information when the image pickup apparatus is moving. An image pickup apparatus and a camera system each having the above control apparatus, a control method corresponding to the above control apparatus also constitute another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of a camera system including an image pickup apparatus according to a first embodiment.

FIG. 2 is a flowchart illustrating update processing of a first correction value according to the first embodiment.

FIG. 3 is a flowchart illustrating selection processing of a correction value according to the first embodiment.

FIG. 4 is a block diagram illustrating the configuration for correcting an angular velocity according to the first embodiment.

FIG. 5 illustrates a user-interface (UI) screen in the first embodiment.

FIG. 6 is a flowchart illustrating an UI operation according to the first embodiment.

FIG. 7 is a block diagram illustrating the configuration of a camera system including an image pickup apparatus and a lens (apparatus) according to a second embodiment.

FIG. 8 is a block diagram illustrating the configuration of a camera system including an image pickup apparatus and an orientation control drive unit according to a third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

### First Embodiment

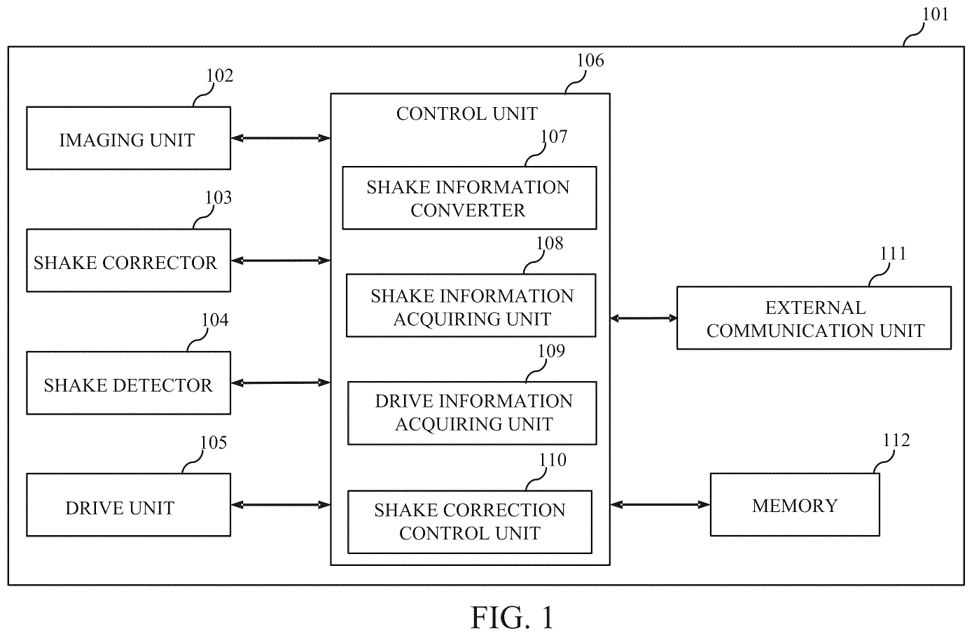

FIG. 1 is a block diagram illustrating the configuration of a camera system including an image pickup apparatus 101 according to this embodiment. The image pickup apparatus 101 is a pan-tilt camera that includes a lens (optical system) (not illustrated) and can be remotely controlled via a network.

The image pickup apparatus 101 includes an imaging unit 102, a shake corrector 103, a shake detector 104, a drive unit 105, a control unit 106, an external communication unit 111, and a memory 112.

The imaging unit 102 includes an image sensor and its control circuit, and captures an object image.

The shake corrector 103 includes a shift lens and its optical control unit, and is an optical image stabilizing unit that corrects the shake of the image pickup apparatus 101 according to instructions from the control unit 106. While the shake corrector 103 is an optical image stabilizing unit in this embodiment, it may also be another unit capable of correcting the shake of the image pickup apparatus 101, such as an electronic image stabilizing unit, an image sensor shift type image stabilizing unit, or a pan-tilt image stabilizing unit.

The shake detector 104 detects a shake amount of the image pickup apparatus 101. In this embodiment, the shake detector 104 is an angular velocity sensor and detects shake amounts in the yaw and pitch directions of the image pickup apparatus 101. While the shake detector 104 is an angular velocity sensor in this embodiment, it may also be another unit capable of detecting the shake amount of the image pickup apparatus 101, such as an acceleration sensor or a detector of a motion vector calculated from video.

In this embodiment, the drive unit 105 is configured to be capable of pan-tilt driving. The drive unit 105 transmits information on the drive direction (moving direction, which will be referred to as a first drive direction hereinafter) of the image pickup apparatus 101 to the drive information acquiring unit 109. The information transmitted by the drive unit 105 to the drive information acquiring unit 109 need not directly indicate the first drive direction, but may instead be information for acquiring the first drive direction, such as the current position and target position of the drive unit 105. In this embodiment, the drive unit 105 transmits a signal regarding the first drive direction to the drive information acquiring unit 109, but this embodiment is not limited to this example. The drive information acquiring unit 109 may be configured to acquire a signal regarding the first drive direction by inputting a signal regarding the first drive direction via an external input device. The drive unit 105 may be configured to perform not only pan-tilt drive but also roll drive, etc. The drive unit 105 may be configured in any known manner and is not limited to this example. For example, the drive unit 105 includes a motor and a support unit that supports the imaging unit so that it can rotate relative to the base unit in at least one of the pan, tilt, and roll directions. The imaging unit includes components relating to image acquisition, such as the imaging unit and the lens, while the base unit includes components relating to overall device control, such as the control unit, external communication unit, and memory. The base unit corresponds to the base in the case of an installed image pickup apparatus, and corresponds to the part held by the user in the case of a handheld image pickup apparatus. The support unit may include a pan drive support unit that supports the imaging unit rotatably in the pan direction, a tilt drive support unit that supports the imaging unit rotatably in the tilt direction, and a roll drive support unit that supports the imaging unit rotatably in the roll direction.

The control unit 106 includes a shake information converter (corrector) 107, a shake information acquiring unit 108, a drive information acquiring unit 109, and a shake correction control unit (control unit) 110. The shake information converter 107 uses the shake information from the shake information acquiring unit 108 and the information on the first drive direction from the drive information acquiring unit 109 to calculate (acquire) a correction value (which will be referred to as a first correction value hereinafter) to be used when calculating a correction amount to be used in the shake corrector 103. The shake information acquiring unit 108 acquires information on the shake amount (shake information) of the image pickup apparatus 101 from the shake detector 104, and sends the acquired information to the shake information converter 107. The drive information acquiring unit 109 acquires information on the first drive direction from the drive unit 105, and sends the acquired information to the shake information converter 107. The shake correction control unit 110 controls the shake corrector 103 to correct the shake of the image pickup apparatus 101. In this embodiment, the control unit 106 having the function of correcting the shake of the image pickup apparatus 101 is provided within the image pickup apparatus 101, but it may be provided in a device separate from the image pickup apparatus 101. For example, if the image pickup apparatus 101 is a lens interchangeable type camera, the control unit 106 may be provided in a lens apparatus that is detachably attached to the image pickup apparatus 101. It may also be provided in a drive device that is attached to the image pickup apparatus 101 and controls the orientation.

The external communication unit 111 communicates via a network regarding the operation and the like of the image pickup apparatus 101.

The memory 112 stores the first correction value acquired by the shake information converter 107. A control apparatus according to the present disclosure includes one or more memories (such as the memory 112 and other unillustrated ROMs) storing instructions, and one or more processors (such as the control unit 106) that, upon execution of the instructions, operate to serve as the shake information converter 107, the shake information acquiring unit 108, and the drive information acquiring unit 109.

In this embodiment, the image pickup apparatus 101 has the lens and the drive unit 105 configured integrally with the image pickup apparatus body, but the present disclosure is not limited to this embodiment. The present disclosure is also applicable to a lens interchangeable type camera and an image pickup apparatus that uses a camera platform or tripod. In a case where the image pickup apparatus 101 is an image pickup apparatus that uses a camera platform or tripod, the drive unit 105 may be provided on the camera platform or tripod.

In this embodiment, the image pickup apparatus 101 includes an external communication unit 111, but it is not necessarily required to have the external communication unit 111.

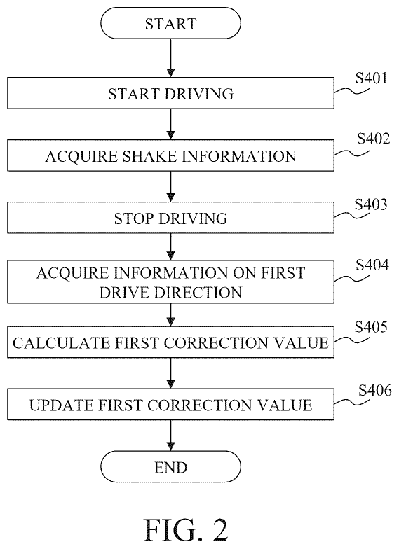

The update processing of the first correction value will be described below. FIG. 2 is a flowchart illustrating the update processing of the first correction value. This flow is performed during initial drive when the image pickup apparatus 101 is started up, or when a command to perform initialization drive is issued by the user. The timing for performing this flow is not limited to the above two. In the following description, abnormal processing due to fraudulent acquisition of shake information or information on the first drive direction will be omitted.

In step S401, the control unit 106 starts driving the drive unit 105 (pan-tilt drive in this embodiment). In a case where the drive speed of the drive unit 105 is slower than the resolution of the shake detector 104, it may be adjusted to a speed equal to or greater than the resolution of the shake detector 104.

In step S402, the shake information acquiring unit 108 acquires shake information from the shake detector 104. At this time, the shake information acquiring unit 108 acquires shake information in an amount of data that allows for calculation of the drive direction based on the shake information (referred to as a second drive direction hereinafter). An angular difference between the first drive direction and the second drive direction occurs when the detection axis of the shake detector 104 shifts from the drive axis of the drive unit 105. Due to this axial shift, when correcting shake by taking into account the drive of the drive unit 105 (movement of the image pickup apparatus 101), the shake is erroneously corrected by a shift amount, reducing the correction effect against the shake. In a case where the second drive direction is calculated, the influence of factors other than shake caused by the drive of the drive unit 105, such as shake of the image pickup apparatus 101, may be reduced. In a case where the second drive direction is calculated from the angular velocity, as the amount of data increases, the ratio of data that becomes noise lowers and the error reduces. Therefore, the amount of data to be acquired is determined based on the required accuracy. In a case where the shake information acquired up to step S403 does not have enough data amount to calculate the second drive direction, this flow is stopped and the first correction value is not updated.

In step S403, the control unit 106 stops driving the drive unit 105.

In step S404, the drive information acquiring unit 109 acquires information about the first drive direction. In this embodiment, the drive information acquiring unit 109 acquires pre-drive position information and current position information from the drive unit 105, calculates the drive amount from the difference, and acquires the first drive direction from the ratio of the pan and tilt drive amounts. In a case where the drive unit 105 has not reached the target position, this flow is stopped and the first correction value is not updated.

In step S405, the shake information converter 107 acquires the second drive direction from the shaking information acquired in step S402, and acquires the first correction value using the angle difference between the first drive direction and the second drive direction. The second drive direction is determined from the ratio of the angles in the yaw and pitch directions, which is obtained by integrating the angular velocity data. This embodiment acquires the drive direction, but if the image pickup apparatus 101 is stationary without shaking and the angular velocity of the shake detector 104 and the drive speed of the drive unit 105 can be accurately output, the angular velocity and drive speed may be used to obtain the first correction value.

In step S406, the shake information converter 107 updates the first correction value stored in the memory 112 to the first correction value acquired in step S405.

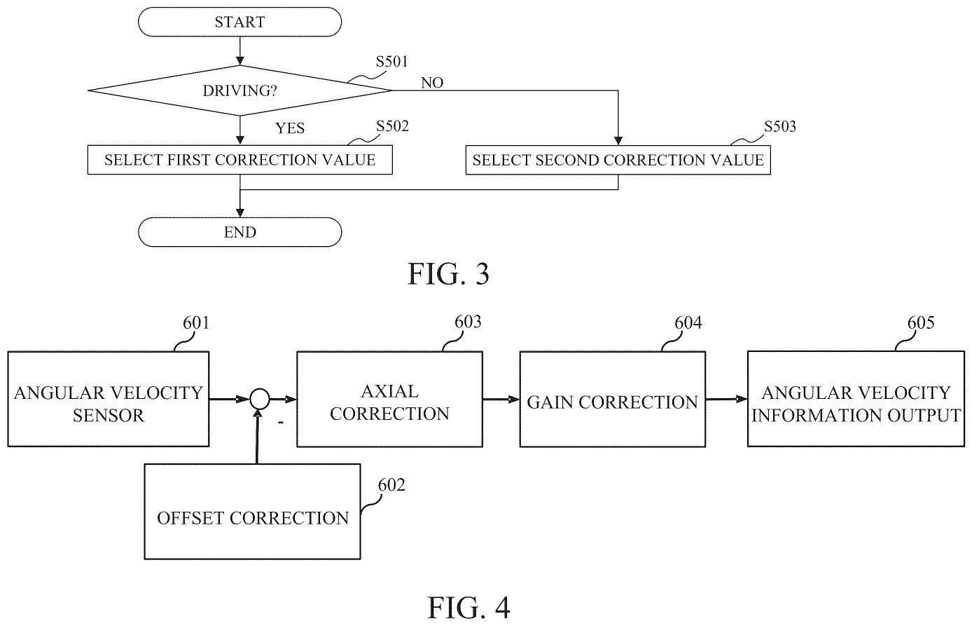

A description will now be given of selection processing of a correction value used when calculating the correction amount used by the shake corrector 103. FIG. 3 is a flowchart illustrating the selection processing of the correction value. Switching the correction value according to this flow can suppress a reduction in the correction effect against shake when the drive unit 105 is stationary and driven.

In step S501, the control unit 106 determines whether the drive unit 105 is driving. In this embodiment, the control unit 106 makes this determination by acquiring the operation status of the drive unit 105. The control unit 106 may also make this determination using a drive command to the drive unit 105 or shake information from the shake detector 104. In a case where the control unit 106 determines that the drive unit 105 is driving, it executes the processing of step S502. In a case where the control unit 106 determines that the drive unit 105 is not driven, it executes the processing of step S503.

In step S502, the control unit 106 selects a first correction value as the correction value to be used when calculating the correction amount to be used by the shake corrector 103.

In step S503, the control unit 106 selects a second correction value based on the correction axis of the shake corrector 103 as the correction value to be used when calculating the correction amount to be used by the shake corrector 103. The second correction value is acquired in advance and stored in the memory 112. In step S502, a first correction value and a second correction value may be selected.

A description will now be given of processing by which the shake correction control unit 110 converts the shake information from the shake detector 104 into a value to be output to the shake corrector 103. FIG. 4 is a block diagram illustrating a configuration for correcting the shake amount of the image pickup apparatus 101. The shake detector 104 will be described as an angular velocity sensor 601.

The angular velocity sensor 601 outputs the shake amount as a digital value of angular velocity.

An offset correction 602 outputs a value for correcting the offset of the angular velocity sensor 601.

An axial correction 603 outputs a value obtained by subtracting the output value of the offset correction 602 from the output value of the angular velocity sensor 601 (correction value before axial correction), and outputs a value that has been processed using the first correction value to correspond to the drive unit 105. In a case where the yaw axis and pitch axis of the correction value before the axial correction are the X and Y axes, respectively, and the first correction value is the angular difference θ between the first and second drive directions, values x and y of the yaw axis and pitch axis output from the axial correction 603 are calculated using the following equations:

$$x = X cos θ + Y sin θ$$

$$y = Y cos θ - X sin θ$$

The above values and methods are merely examples, and the first correction value and calculation method may differ from the above.

A gain correction 604 multiplies the output value of the axial correction 603 by an amplification factor.

An angular velocity information output 605 outputs the output value of the gain correction 604 to the shake corrector 103. The shake corrector 103 corrects the shake based on the output value of angular velocity information output 605.

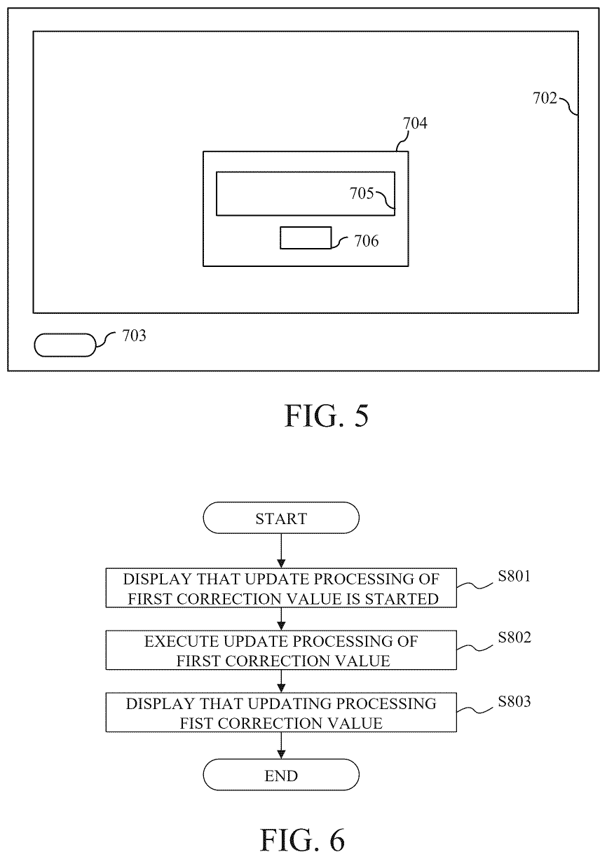

The UI screen according to this embodiment will now be described. FIG. 5 illustrates the UI screen. The UI screen in FIG. 5 is a screen operable by the user when updating the first correction value.

A video output unit 702 outputs video of the image pickup apparatus 101 via the external communication unit 111.

A correction-value update button 703 is a button for inputting the start of the update processing of the first correction value.

Using the UI screen in FIG. 5 can limit a user operation when updating the first correction value, improve the accuracy of acquiring the first correction value, and enhance the correction effect against shake achieved by using the first correction value.

A pop-up window 704 is a window that pops up at the start and end of the update processing of the first correction value. The pop-up window 704 includes a display field 705 and a button 706, and remains displayed until button 706 is pressed. The display field 705 is a field for displaying a message. The button 706 is a button for closing the pop-up window 704.

A description will now be given of the processing that occurs when the correction-value update button 703 is pressed. FIG. 6 is a flowchart illustrating the US operation.

In step S801, the control unit 106 pops up the pop-up window 704, and displays in the display field 705 a message that the update processing of the first correction value has started. Pressing the button 706 closes the pop-up window 704.

In step S802, the control unit 106 performs the update processing of the first correction value.

In step S803, the control unit 106 pops up the pop-up window 704, and displays in the display field 705 a message that the update processing of the first correction value has been completed. Pressing the button 706 closes the pop-up window 704.

As described above, the configuration according to this embodiment calculates a correction value based on information on the drive direction of the image pickup apparatus 101 and shake information from the shake detector 104, which the correction value is used for calculating the correction amount to be used by the shake corrector 103 when the drive unit 105 is driving. Thereby, in a case where the drive unit 105 is driving, this embodiment can correct shake with high accuracy.

### Second Embodiment

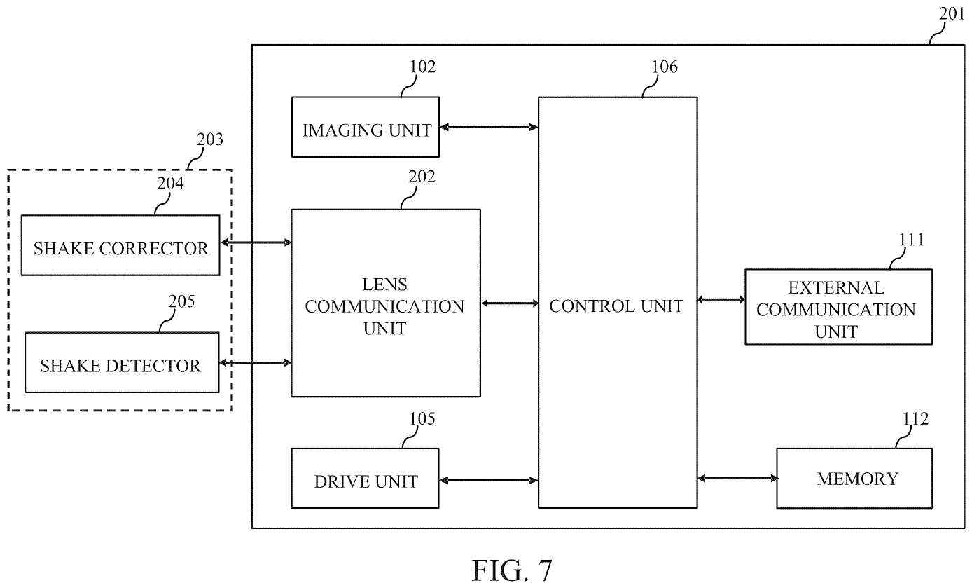

FIG. 7 is a block diagram illustrating the configuration of a camera system including an image pickup apparatus 201 and a lens 203 according to this embodiment. This embodiment will discuss configurations different from those of the first embodiment, and will designate the same components as those of the first embodiment by the same reference numerals, and omit a description thereof.

The lens 203 is an interchangeable lens, and is attachable to and detachable from the image pickup apparatus 201. The lens 203 includes a shake corrector 204 and a shake detector 205. The shake corrector 204 is an optical image stabilizing unit that includes a shift lens and its optical control unit, and corrects the shake of the image pickup apparatus 201 based on a signal transmitted from a lens communication unit 202. The shake detector 205 detects the shake amount of the lens 203. In this embodiment, the shake detector 205 is an angle sensor that detects the shake amounts of the lens 203 in the yaw and pitch directions. The shake detector 205 transmits information on the shake amount of the lens 203 (shake information) to the lens communication unit 202.

The image pickup apparatus 201 includes the lens communication unit 202, the imaging unit 102, the drive unit 105, the control unit 106, the external communication unit 111, and the memory 112. The lens communication unit 202 communicates with the lens 203. The lens communication unit 202 transmits shake information from the shake detector 205 to the control unit 106, and transmits a signal from the control unit 106 to operate the shake corrector 204. The image pickup apparatus 201 may have a shake corrector separate from the shake corrector 204 of the lens 203.

In this embodiment, when the lens 203 is attached or detached, the correction value acquired by the shake information converter stored in the memory 112 is initialized. When the lens 203 is attached or detached, if individual identification of the lens 203 can be performed through the lens communication unit 202, etc., this is not the case, and a different correction value may be stored for each attached lens 203. In a case where the lens 203 that has no shake detector 205 is attached, the update processing of the first correction value may not be performed. At this time, the correction-value update button 703 may be grayed out and prohibited from being pressed.

The configuration according to this embodiment can correct shake with high accuracy even when a different lens 203 is attached to the lens interchangeable type image pickup apparatus 201 and even when the drive unit 105 is driving.

### Third Embodiment

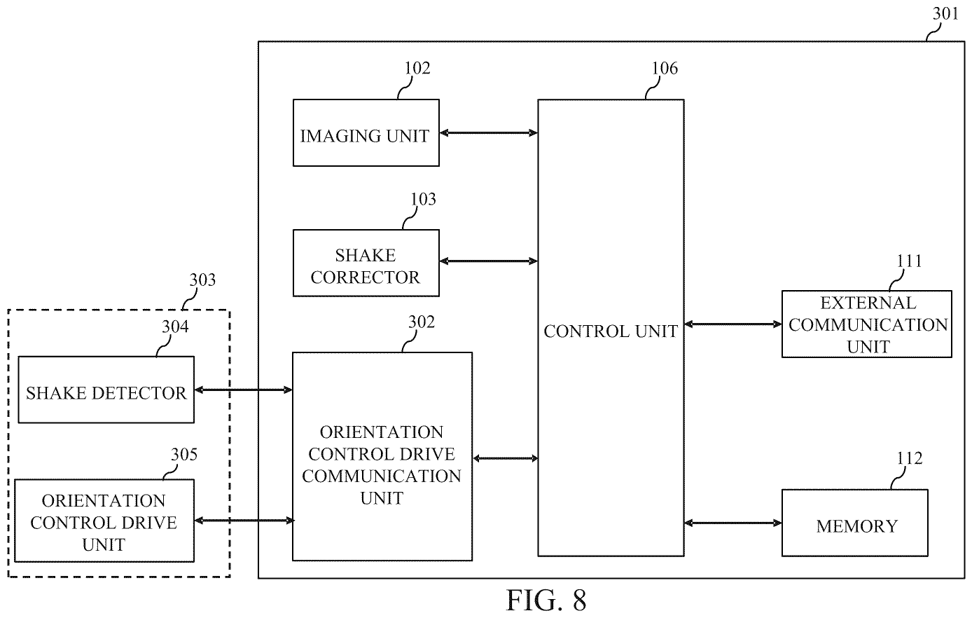

FIG. 8 illustrates a configuration example of a camera system including an image pickup apparatus 301 and an orientation control drive unit 305 according to this embodiment. This embodiment will discuss configurations different from those of the first embodiment, and will designate the same components as those of the first embodiment by the same reference numerals, and omit a description thereof.

The orientation control drive unit 303 is an apparatus for orientation control drive of the image pickup apparatus 301, and includes a shake detector 304 and an orientation control drive unit 305. The shake detector 304 detects the shake amount of the orientation control drive unit 303. In this embodiment, the shake detector 304 is a gravity acceleration sensor. The shake detector 304 can detect a drive amount of the orientation control drive unit 305 while the orientation control drive unit 305 is driving. The orientation control drive unit 305 is configured to be capable of parallel drive in both the horizontal and vertical directions. The orientation control drive unit 305 transmits information on the first drive direction to the image pickup apparatus 301. The information on the first drive direction may not directly indicate the first drive direction, but may be information for acquiring the first drive direction, such as the current position and target position of the orientation control drive unit 305.

The image pickup apparatus 301 includes the orientation control drive communication unit 302, the imaging unit 102, the shake corrector 103, the control unit 106, the external communication unit 111, and the memory 112. The orientation control drive communication unit 302 communicates with the orientation control drive unit 303. The orientation control drive communication unit 302 transmits information on the shake amount from the shake detector 304 and drive information for the orientation control drive unit 305 to the control unit 106.

The configuration of this embodiment can correct shake with high accuracy in the configurations of the image pickup apparatus 301 and the orientation control drive unit 303, even when the orientation control drive unit 305 is driving, regardless of the installation location.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. One or more of the functional blocks illustrated in FIG. 1 etc. may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide a control apparatus, an image pickup apparatus, a camera system, a control method, and a storage medium, each of which can perform image stabilization by properly using a motion vector.

This application claims the benefit of Japanese Patent Application No. 2025-029092, filed on Feb. 26, 2025, and which is hereby incorporated by reference herein in its entirety.

What is claimed is:

1. A control apparatus for use in a camera system including an image pickup apparatus, the control apparatus comprising:
one or more memories storing instructions; and
one or more processors that, upon execution of the instructions, operate to:
acquire information on a moving direction of the image pickup apparatus and shake information of the camera system, and
correct shake information according to the information on the moving direction and the shake information when the image pickup apparatus is moving.

2. The control apparatus according to claim 1, wherein the one or more processors operate to control correction of shake of the image pickup apparatus based on the shake information that has been corrected by the one or more processors.

3. The control apparatus according to claim 2, wherein the one or more processors operate to control the correction when the image pickup apparatus is moving, using a first correction value based on the information on the moving direction and the shake information.

4. The control apparatus according to claim 3, wherein the one or more processors operate to acquire the first correction value according to a difference between the information on the moving direction and a moving direction of the image pickup apparatus acquired using the shake information.

5. The control apparatus according to claim 2, wherein when the image pickup apparatus is not moving, the one or more processors operate to control the correction using a second correction value based on a correction axis of a shake corrector configured to perform the correction in accordance with an instruction from the one or more processors.

6. The control apparatus according to claim 1, wherein in a case where an abnormality is detected when the image pickup apparatus is moving, the one or more processors operate not to correct the shake information.

7. The control apparatus according to claim 1, wherein the one or more processors operate to acquire shake information on a first axis and shake information on a second axis different from the first axis.

8. The control apparatus according to claim 1, wherein the one or more processors operate to acquire information on a moving direction of the image pickup apparatus along one or more axes.

9. An image pickup apparatus comprising:
the control apparatus according to claim 1; and
an image sensor.

10. A camera system comprising:
the image pickup apparatus according to claim 9; and
an optical system.

11. A camera system comprising:
the image pickup apparatus according to claim 9; and
a drive apparatus configured to move the image pickup apparatus.

12. A control method for use in a camera system including an image pickup apparatus, the control method comprising:
acquiring information on a moving direction of the image pickup apparatus and shake information of the camera system, and
correcting shake information according to the information on the moving direction and the shake information when the image pickup apparatus is moving.

13. A non-transitory computer-readable storage medium storing a program that causes a computer to execute the control method according to claim 12.
